(19) United States
(12) Patent Application Publication
(10) Pub. No.: US 2026/0291106 A1
(43) Pub. Date: Sep. 24, 2026

(54) TERMINAL BLOCK

(71) Applicant: Yazaki Corporation, Tokyo (JP)

(72) Inventor: Katsuya NAKANO, Shizuoka (JP)

(73) Assignee: Yazaki Corporation, Tokyo (JP)

(21) Appl. No.: 19/539,508

(22) Filed: Feb. 13, 2026

(30) Foreign Application Priority Data
Mar. 18, 2025 (JP) 2025-043735

(51) Int. Cl. H01R 13/11; H01R 13/04; H01R 13/115; H01R 13/41; H01R 13/514

(52) U.S. Cl. CPC H01R 13/113; H01R 13/04; H01R 13/115; H01R 13/41; H01R 13/514

(57) ABSTRACT

A first busbar includes: a first terminal connection part; and a wedge-shaped connection part being V-shaped and cantilevered and including a fold point positioned on a side closer to a second busbar. A second busbar includes: a second terminal connection part; and a fitted connection part allowing the wedge-shaped connection part inserted from the fold point to be fitted into the fitted connection part. The wedge-shaped connection part includes: a first piece being on a fixed end side and connected to the first terminal connection part; and a second piece being on a free end side and connected to the first piece via the fold point. The fitted connection part includes: a first connection part exerting a first pressing force on the outer wall of the first piece; and a second connection part exerting a second pressing force on the outer wall of the second piece.

### CROSS-REFERENCE TO RELATED APPLICATION(S)

The present application claims priority to and incorporates by reference the entire contents of Japanese Patent Application No. 2025-043735 filed in Japan on Mar 18, 2025.

### BACKGROUND OF THE INVENTION

### 1. Field of the Invention

The present invention relates to a terminal block.

### 2. Description of the Related Art

A conventional terminal block including a first terminal block and a second terminal block configured to be fitted and connected to each other has been known. The first terminal block includes: a first busbar configured to establish electrical connections to one electrical apparatus; and a first case configured to accommodate the first busbar. The second terminal block includes: a second busbar configured to establish electrical connections to another electrical apparatus; and a second case configured to accommodate the second busbar. For example, this type of terminal block is disclosed in JP 2022 – 187 559 A and JP 2022 – 187 540 A. In the terminal block, the first terminal block includes an elastic member so that the first busbar and the second busbar press against each other to generate contact pressure between the first busbar and the second busbar.

To generate contact pressure between the first busbar and the second busbar, the conventional terminal block needs to include not only the elastic member, but also a member configured to hold the elastic member in the first case. As a result, the structure of the first terminal block is complicated. Therefore, in the terminal block, a male terminal part of one of the first busbar and the second busbar is inserted and fitted into a female terminal part of the other one thereof and the male terminal part is held tightly by the female terminal part by making use of the springiness of the female terminal part, whereby contact pressure can be generated between the first busbar and the second busbar with a simple structure. However, in the first busbar and the second busbar, there is a possibility that, when the male terminal part is inserted and fitted into the female terminal part, for example, the male terminal part hits the periphery of an insertion opening of the female terminal part, which reduces the workability of assembling the first terminal block to the second terminal block.

### SUMMARY OF THE INVENTION

An object of the present invention is to provide a terminal block capable of enhancing the workability of assembly.

In order to achieve the above mentioned object, a terminal block according to one aspect of the present invention includes a first terminal block including a first busbar and a case configured to accommodate the first busbar; and a second terminal block including a second busbar and a busbar holding member configured to hold the second busbar, and configured to be fitted and connected to the first terminal block at an assembly completion position, wherein the first busbar includes a first terminal connection part configured to establish physical and electrical connections to a terminal fitting of a first electrical apparatus, and a wedge-shaped connection part being V-shaped and cantilevered and including a fold point positioned on a side closer to the second busbar, the second busbar includes a second terminal connection part configured to establish physical and electrical connections to a terminal fitting of a second electrical apparatus, and a fitted connection part configured to allow the wedge-shaped connection part inserted from the fold point to be fitted into the fitted connection part, the wedge-shaped connection part includes a first piece being on a fixed end side and connected to the first terminal connection part, and a second piece being on a free end side and connected to the first piece via the fold point, and the fitted connection part includes a first connection part configured to exert a first pressing force on an outer wall of the first piece at the assembly completion position, and a second connection part configured to exert a second pressing force on an outer wall of the second piece at the assembly completion position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block after fitting connection according to an embodiment;

FIG. 2 is a cross-sectional view taken along line X1-X1 in FIG. 1;

FIG. 3 is a perspective view of the terminal block before fitting connection according to the embodiment;

FIG. 4 is a perspective view, from another angle, of the terminal block before fitting connection according to the embodiment;

FIG. 5 is a cross-sectional view taken along line X1-X1 in FIG. 3;

FIG. 6 is an exploded perspective view of a first terminal block according to the embodiment;

FIG. 7 is an exploded perspective view of a second terminal block according to the embodiment;

FIG. 8 is an explanatory diagram illustrating angles of a wedge-shaped connection part and a fitted connection part;

FIG. 9 is a cross-sectional view of a terminal block after fitting connection according to a modification;

FIG. 10 is a perspective view of the terminal block before fitting connection according to the modification;

FIG. 11 is a perspective view, from another angle, of the terminal block before fitting connection according to the modification;

FIG. 12 is a cross-sectional view taken along line X2-X2 in FIG. 10; and

FIG. 13 is an exploded perspective view of a second terminal block according to the modification.

### DETAILED DESCRIPTION OF THE PREFERRED EMBODIMENTS

Hereinafter, an embodiment of a terminal block according to the present invention will be described in detail with reference to the drawings. Note that the present invention is not limited by the embodiments.

### Embodiments

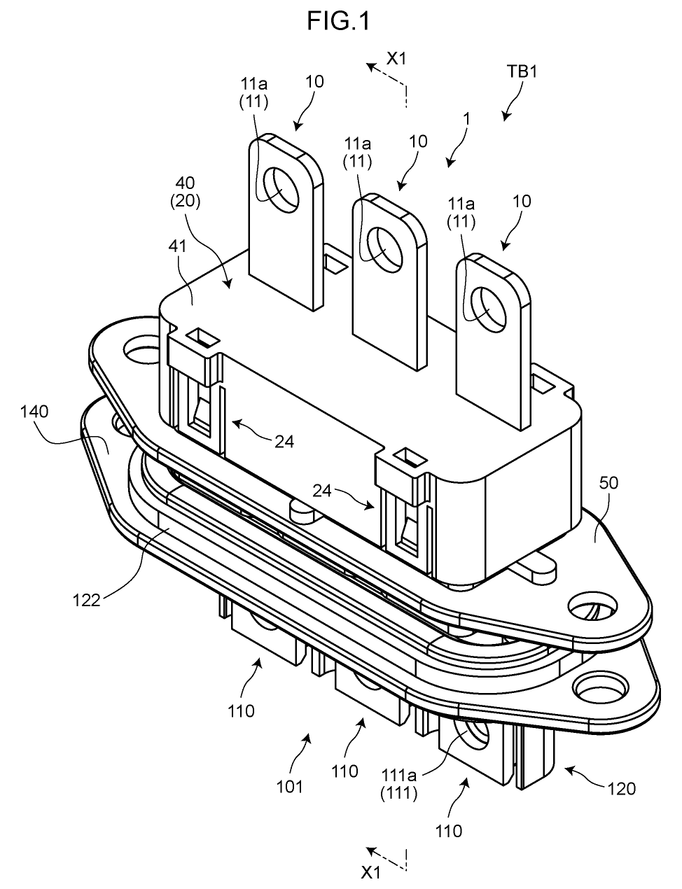

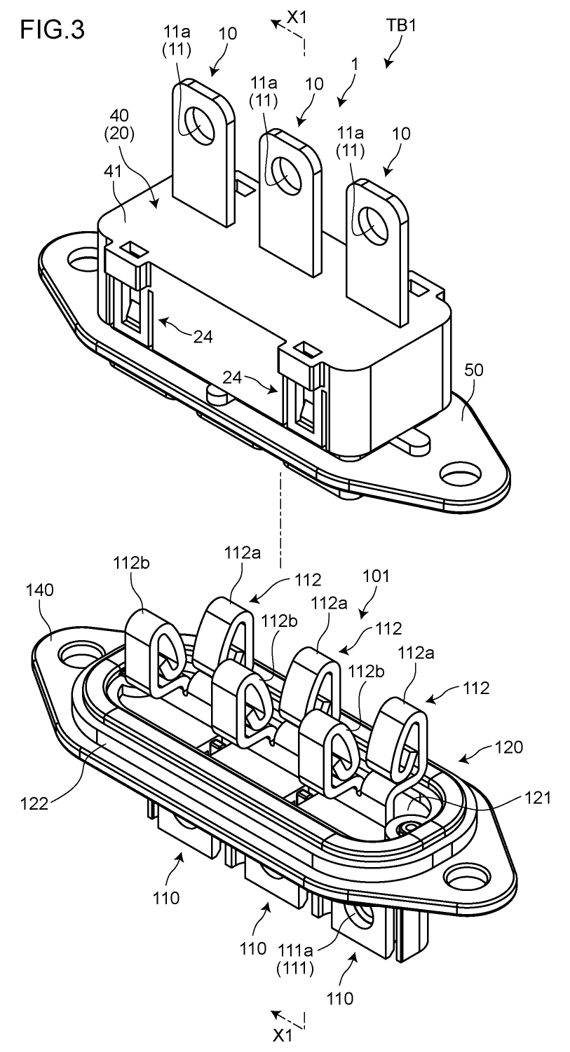

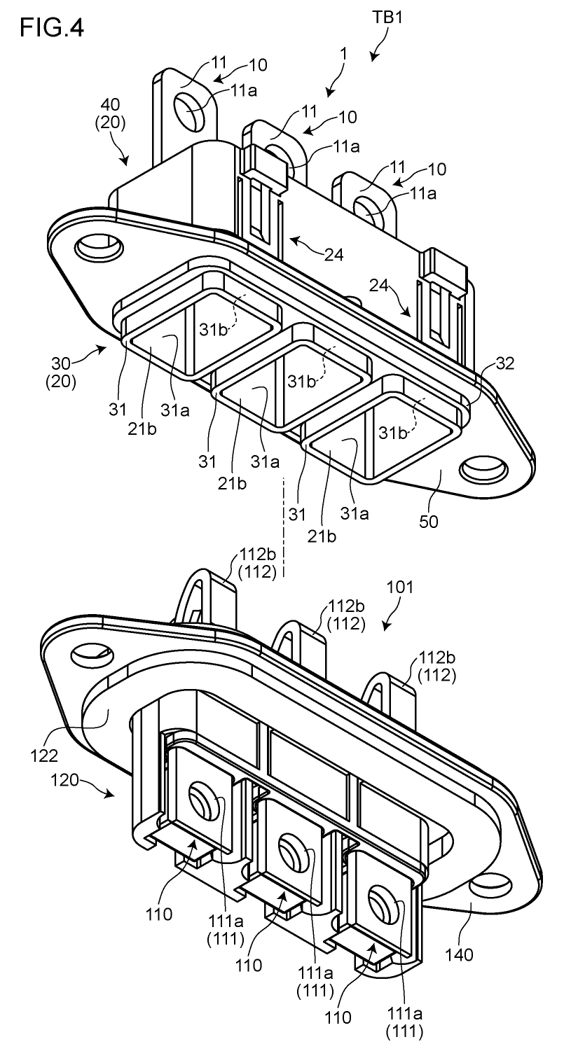

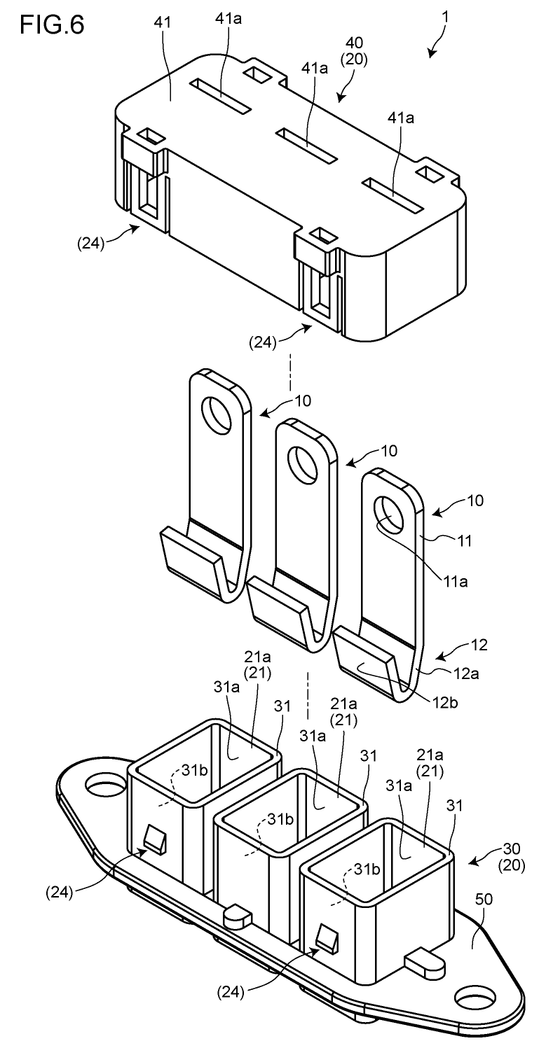

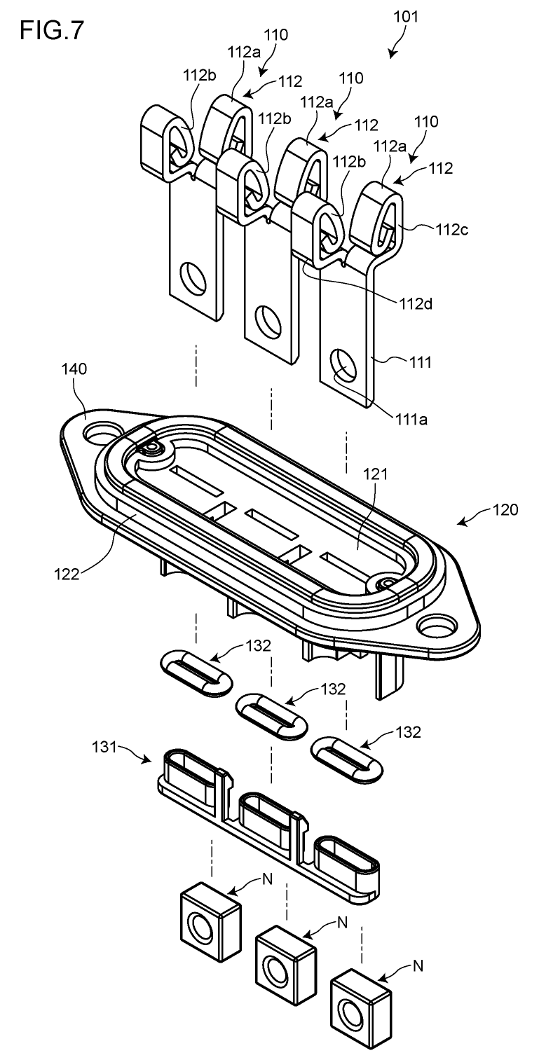

One embodiment of a terminal block according to the present invention will be described, based on FIGS. 1 to 8.

A reference symbol TB1 in FIGS. 1 to 5 represents the terminal block of the present embodiment. The terminal block TB1 includes a first terminal block 1 and a second terminal block 101 configured to be fitted and connected to each other at an assembly completion position and thereby establish electrical connections. In the terminal block TB1, the first terminal block 1 is assembled to a first casing (not illustrated) closer to a first electrical apparatus and establishes electrical connections to the first electrical apparatus. The second terminal block 101 is assembled to a second casing (not illustrated) closer to a second electrical apparatus and establishes electrical connections to the second electrical apparatus. In the terminal block TB1, by assembling the first casing to the second casing, the first terminal block 1 is fitted and connected to the second terminal block 101, whereby the first electrical apparatus is electrically connected to the second electrical apparatus.

The first terminal block 1 includes a busbar (hereinafter referred to as "a first busbar") 10 (FIGS. 1 to 6). The second terminal block 101 includes a busbar (hereinafter referred to as "a second busbar") 110 (FIGS. 1 to 5 and 7). The first busbar 10 and the second busbar 110 are plate-shaped conductive members that are press-formed from a metal plate as a base material.

The first busbar 10 includes a terminal connection part (hereinafter referred to as "a first terminal connection part") 11 configured to establish physical and electrical connections to a terminal fitting (not illustrated) of the first electrical apparatus (FIGS. 1 to 6). The first terminal connection part 11 is formed in the shape of a flat plate having a plane along the fitting connection direction of the first terminal block 1 and the second terminal block 101. For example, the first terminal connection part 11 is formed in the shape of a rectangular flat plate whose longitudinal direction is equal to the fitting connection direction. The first terminal connection part 11 includes a circular through hole (hereinafter referred to as "a male screw insertion hole") 11a and is fastened to the terminal fitting of the first electrical apparatus by using a male screw member (not illustrated) passing through the male screw insertion hole 11a and a female screw member (not illustrated).

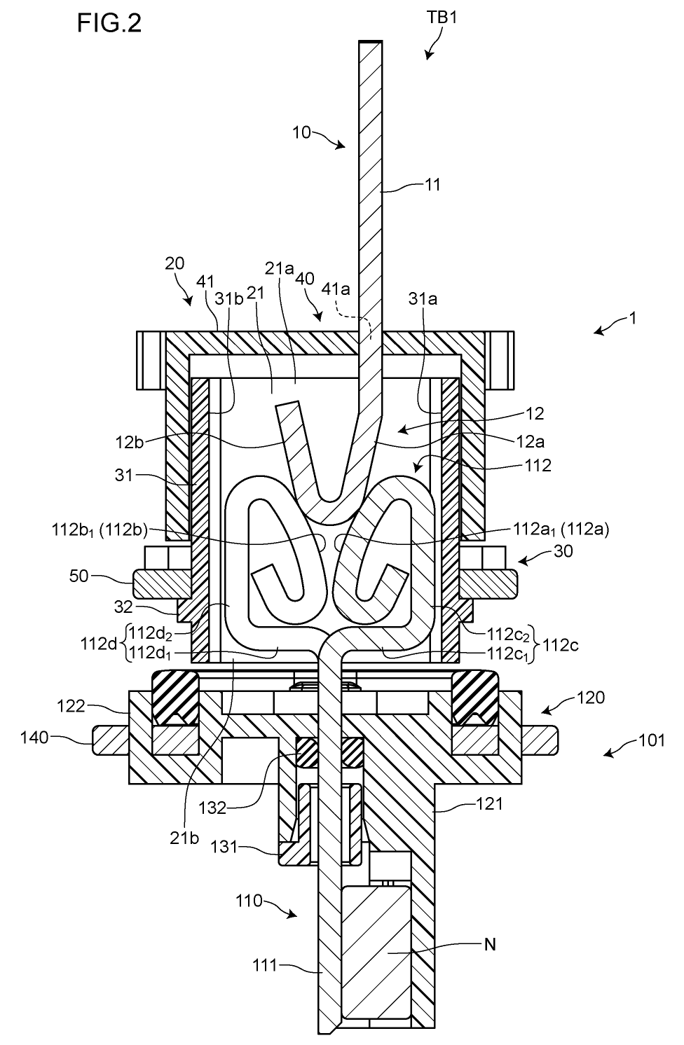

The second busbar 110 includes a terminal connection part (hereinafter referred to as "a second terminal connection part") 111 configured to establish physical and electrical connections to a terminal fitting (not illustrated) of the second electrical apparatus (FIGS. 1 to 5 and 7). The second terminal connection part 111 is formed in the shape of a flat plate having a plane along the fitting connection direction of the first terminal block 1 and the second terminal block 101. For example, the second terminal connection part 111 is formed in the shape of a rectangular flat plate whose longitudinal direction is equal to the fitting connection direction. The second terminal connection part 111 includes a circular through hole (hereinafter referred to as "a male screw insertion hole") 111a and is fastened to the terminal fitting of the second electrical apparatus by using a male screw member (not illustrated) passing through the male screw insertion hole 111a and a female screw member N (FIGS. 2, 5, and 7).

The first busbar 10 further includes a wedge-shaped connection part 12 being V-shaped and cantilevered and including a fold point positioned on the second busbar 110 side (FIGS. 2, 5, and 6). The wedge-shaped connection part 12 includes: a first piece 12a being on a fixed end side and connected to the first terminal connection part 11; and a second piece 12b being on a free end side and connected to the first piece 12a via the fold point. In the wedge-shaped connection part 12 described herein, the fixed end is one longitudinal end of the first terminal connection part 11.

The second busbar 110 further includes a fitted connection part 112 configured to allow the wedge-shaped connection part 12 inserted from the fold point to be fitted thereinto (FIGS. 2 to 5 and 7). The fitted connection part 112 includes: a first connection part 112a configured to exert a first pressing force on the outer wall of the first piece 12a at an assembly completion position of the first terminal block 1 and the second terminal block 101; and a second connection part 112b configured to exert a second pressing force on the outer wall of the second piece 12b at the assembly completion position.

Thus, in the terminal block TB1 of the present embodiment, the wedge-shaped connection part 12 is in a V shape formed by the first piece 12a and the second piece 12b, and the fitted connection part 112 is in a V shape formed by the first connection part 112a and the second connection part 112b, and the wedge-shaped connection part 12 in the V shape is fitted into the V-bank of the fitted connection part 112. Thus, the terminal block TB1 can reduce redoing work such as reassembly caused by, for example, a fitting trouble between the wedge-shaped connection part 12 and the fitted connection part 112 when the first terminal block 1 is assembled to the second terminal block 101. Thus, the terminal block TB1 of the present embodiment can enhance the workability of assembling the first terminal block 1 to the second terminal block 101.

The fitted connection part 112 undergoes elastic deformation by receiving input from the first piece 12a and the second piece 12b and exerts reaction forces associated with the elastic deformation as pressing forces on the first piece 12a and the second piece 12b, respectively. Thus, the terminal block TB1 of the present embodiment can physically and electrically connect the wedge-shaped connection part 12 to the fitted connection part 112 at the assembly completion position of the first terminal block 1 and the second terminal block 101, without controlling production precision related to the shapes and positions of the wedge-shaped connection part 12 and the fitted connection part 112 at the assembly completion position with a high degree of precision. Furthermore, the terminal block TB1 of the present embodiment can generate contact pressure between the wedge-shaped connection part 12 and the fitted connection part 112 without providing a conventional elastic member. Thus, the terminal block TB1 of the present embodiment can enhance the workability of assembling the first terminal block 1 to the second terminal block 101 at low cost.

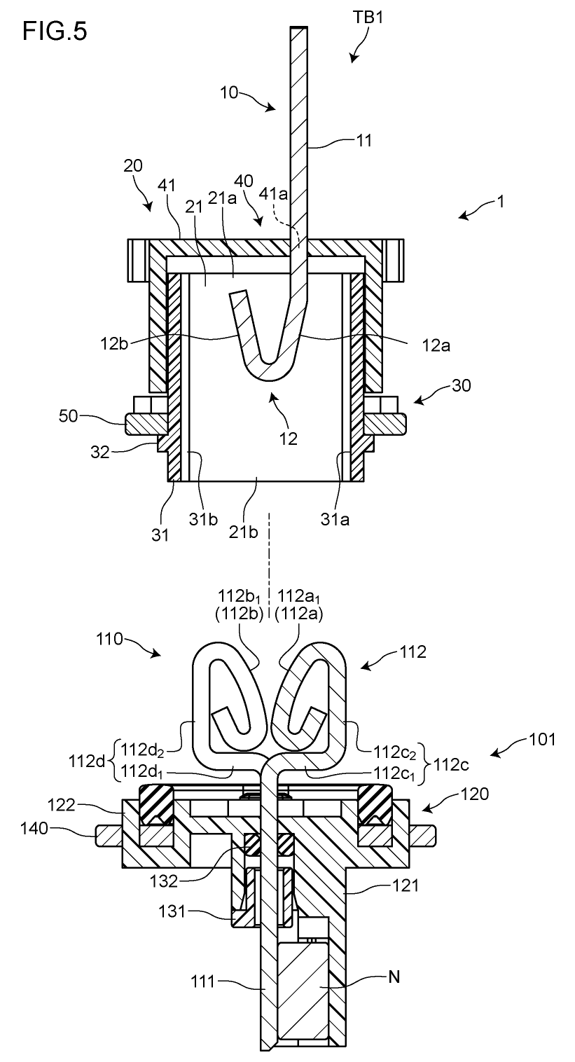

Specifically, the fitted connection part 112 of the present embodiment includes: a first coupling part 112c coupling the second terminal connection part 111 to the first connection part 112a; and a second coupling part 112d coupling the second terminal connection part 111 to the second connection part 112b (FIGS. 2, 5 ,and 7). The first coupling part 112cand the second coupling part 112d are disposed at one longitudinal end of the second terminal connection part 111. The first coupling part 112cand the second coupling part 112d described herein are displaced from each other in a direction along the edge of the end of the second terminal connection part 111.

The first coupling part 112c is in an L shape formed by two rectangular flat plate-shaped pieces intersecting at right angles (FIGS. 2, 5, and 7). The first coupling part 112cincludes: one piece 112c₁ protruding from one longitudinal end of the second terminal connection part 111 toward one direction perpendicular to the plane of the second terminal connection part 111; and another piece 112c₂ protruding from a protruding end of the one piece 112c₁ toward the first busbar 10 side. A protruding end of the other piece 112c₂ of the first coupling part 112c is coupled to the first connection part 112a.

The first connection part 112a is formed in a J shape in such a manner that one piece of the first connection part 112a is folded back from the first coupling part 112c toward the fitting direction of the wedge-shaped connection part 12 and another piece of the first connection part 112a is folded back from a distal end of the folded-back one piece toward the other piece 112c₂ of the first coupling part 112c. The one piece of the first connection part 112a includes a first facing wall 112a₁ disposed to face the outer wall of the first piece 12a and configured to exert the first pressing force on the outer wall of the first piece 12a (FIGS. 2 and 5).

The second coupling part 112d is in an L shape formed by two rectangular flat plate-shaped pieces intersecting at right angles (FIGS. 2, 5, and 7). The second coupling part 112d includes: one piece 112d₁ protruding from the one longitudinal end of the second terminal connection part 111 toward the other direction perpendicular to the plane of the second terminal connection part 111; and another piece 112d₂ protruding from a protruding end of the one piece 112d₁ toward the first busbar 10 side. A protruding end of the other piece 112d₂ of the second coupling part 112d is coupled to the second connection part 112b.

The second connection part 112b is formed in a J shape in such a manner that one piece of the second connection part 112b is folded back from the second coupling part 112d toward the fitting direction of the wedge-shaped connection part 12 and another piece of the second connection part 112bis folded back from a distal end of the folded-back one piece toward the other piece 112d₂ of the second coupling part 112d. The one piece of the second connection part 112bincludes a second facing wall 112b₁ disposed to face the outer wall of the second piece 12b and configured to exert the second pressing force on the outer wall of the second piece 12b (FIGS. 2 and 5).

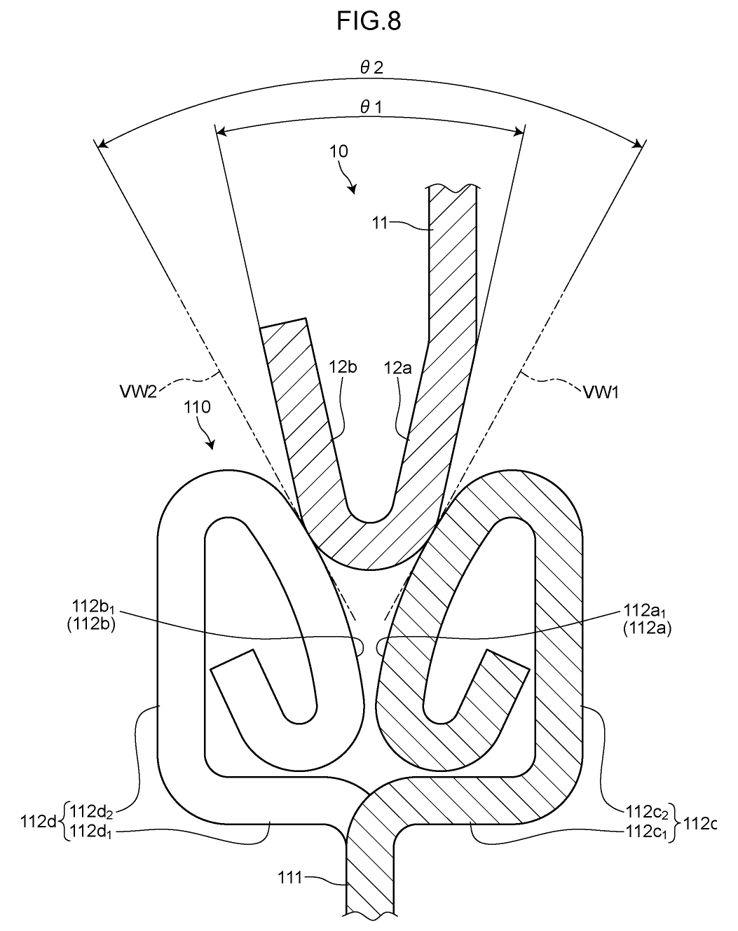

In the fitted connection part 112, the first connection part 112aand the second connection part 112bare disposed to form a V shape. In the first connection part 112aand the second connection part 112b, a first virtual wall VW1 including the first facing wall 112a₁ and a second virtual wall VW2 including the second facing wall 112b₁ form an angle θ2 larger than an angle θ1 formed by the first piece 12a and the second piece 12b of the wedge-shaped connection part 12 (FIG. 8).

In the first connection part 112aand the second connection part 112bdescribed herein, the first facing wall 112a₁ and the second facing wall 112b₁ are formed so that the angle θ2 formed by the first virtual wall VW1 and the second virtual wall VW2 is larger than the angle θ1 formed by the first piece 12a and the second piece 12b on the insertion opening side serving as an entrance for the wedge-shaped connection part 12. In the first connection part 112aand the second connection part 112b described herein, the first facing wall 112a₁ and the second facing wall 112b₁ are formed in an arc shape to gradually change the angle θ2 from the insertion opening side toward the fitting direction of the wedge-shaped connection part 12. Toward the fitting direction of the wedge-shaped connection part 12, the angle θ2 gradually decreases from an angle larger than the angle θ1, then becomes equivalent to the angle θ1, and then gradually becomes smaller than the angle θ1.

The first terminal block 1 includes a case 20 configured to accommodate the first busbar 10 (FIGS. 1 to 6). In the case 20, an accommodation chamber 21 configured to accommodate the first busbar 10 is provided. The case 20 includes a housing 30 in which the accommodation chamber 21 is formed (FIGS. 2 and 4 to 6). The case 20 further includes a cover 40 configured to be assembled to the housing 30 (FIGS. 1 to 6). The housing 30 and the cover 40 are molded from an insulating material such as synthetic resin.

The housing 30 includes a tubular part 31 inside which the accommodation chamber 21 is provided and whose tube axis direction is aligned with the fitting connection direction of the first terminal block 1 and the second terminal block 101 (FIG. 2 and FIGS. 4 to 6). The first busbar 10 is accommodated in the accommodation chamber 21 inside the tubular part 31. The tubular part 31 described herein has a rectangular tube shape and allows the wedge-shaped connection part 12 to be disposed in the accommodation chamber 21 and allows the first terminal connection part 11 to protrude outward from an opening 21a at one end in the tube axis direction of the tubular part 31 (FIGS. 2 and 5).

In the tubular part 31, one of a pair of inner walls facing each other (hereinafter referred to as "one inner wall 31a") is disposed to face the outer wall of the first piece 12a of the wedge-shaped connection part 12 with a space left therebetween, and another one of the pair of inner walls (hereinafter referred to as "the other inner wall 31b") is disposed to face the outer wall of the second piece 12b of the wedge-shaped connection part 12 with a space left therebetween (FIG. 2).

In the tubular part 31, when the first terminal block 1 is fitted and connected to the second terminal block 101, the fitted connection part 112 is inserted and fitted into the accommodation chamber 21 from an opening 21b at the other end in the tube axis direction of the tubular part 31 (FIGS. 2, 4 and 5). In the tubular part 31, by inserting and fitting the fitted connection part 112 into the accommodation chamber 21 from the opening 21b, the wedge-shaped connection part 12 inside the tubular part 31 is fitted into the V-bank of the fitted connection part 112. At this time, in the fitted connection part 112, the first connection part 112aand the other piece 112c₂ of the first coupling part 112c are fitted between the one inner wall 31a and the first piece 12a of the wedge-shaped connection part 12, and the second connection part 112band the other piece 112d₂ of the second coupling part 112d are fitted between the other inner wall 31b and the second piece 12b of the wedge-shaped connection part 12.

The fitted connection part 112 is configured such that, in the accommodation chamber 21, the other piece 112c₂of the first coupling part 112c contacts the one inner wall 31aand the other piece 112d₂ of the second coupling part 112dcontacts the other inner wall 31b. Thus, in the fitted connection part 112, the other piece 112c₂ and the other piece 112d₂are sandwiched between the one inner wall 31aand the other inner wall 31b. Thus, in the accommodation chamber 21, the one inner wall 31areceives the first pressing force exerted on the first piece 12a by the first connection part 112afrom the other piece 112c₂of the first coupling part 112c, and the other inner wall 31b receives the second pressing force exerted on the second piece 12b by the second connection part 112b from the other piece 112d₂ of the second coupling part 112d. Therefore, in the fitted connection part 112, the first pressing force can be exerted on the first piece 12a by the first connection part 112a without loss, and the second pressing force can be exerted on the second piece 12b by the second connection part 112b without loss.

The cover 40 is molded in a cap shape to cover the tubular part 31 from one end in the tube axis direction of the tubular part 31. The cover 40 includes a lid part 41 configured to close the opening 21a at the one end of the tubular part 31 (FIGS. 1 to 3, 5 and 6). The lid part 41 includes a through hole (hereinafter referred to as "a terminal insertion hole") 41a that allows the first terminal connection part 11 to pass therethrough (FIGS. 2, 5, and 6).

For example, the cover 40 is insert-molded by pouring a liquid synthetic resin material into a mold in which the first busbar 10 is placed. As a result, the first busbar 10 is integrated with the cover 40 and held by the cover 40, hence, by assembling the cover 40 to the housing 30, the first busbar 10 is held in the case 20. When the wedge-shaped connection part 12 is fitted and connected to the fitted connection part 112, a force that the wedge-shaped connection part 12 receives from the fitted connection part 112 (a force in the direction of insertion fitting of the fitted connection part 112) can be received by the lid part 41 of the cover 40. Thus, between the wedge-shaped connection part 12 and the fitted connection part 112, the first pressing force can be exerted on the first piece 12a by the first connection part 112a without loss and the second pressing force can be exerted on the second piece 12b by the second connection part 112b without loss.

In the housing 30 described herein, three tubular parts 31 are disposed perpendicularly to the tube axis direction. The housing 30 includes a flange part 32 being in a square ring shape and disposed to hold the three tubular parts 31 (FIGS. 2, 4, and 5). The flange part 32 is disposed on the outer walls of the tubular parts 31.

The cover 40 described herein is formed in the cap shape to cover the three tubular parts 31 collectively from one end of each tubular part 31 in the tube axis direction. Therefore, in the lid part 41, a terminal insertion hole 41a is formed for the opening 21a of each tubular part 31. The housing 30 and the cover 40 are provided with a locking mechanism 24 configured to cause the housing 30 and the cover 40 to hold each other by letting an engagement part provided in one of the housing 30 and the cover 40 get caught on a hook provided in the other one thereof (FIGS. 1, 3, 4, and 6).

The first terminal block 1 includes a metal plate member 50 disposed to be superimposed on the flat surface of the flange part 32 on the cover 40 side (FIGS. 1 to 6). The plate member 50 is an annular flat plate member having an outer circumferential edge protruding beyond the outer circumferential edge of the flange part 32. The first terminal block 1 is attached to the first casing by fixing the outer circumferential edge of the plate member 50 to the first casing with a male screw member (not illustrated). Note that, in the case 20, for example, the plate member 50 is placed in a mold, and a liquid synthetic resin material is poured into the mold to insert-mold the housing 30.

The second terminal block 101 includes a busbar holding member 120 configured to hold the second busbar 110 (FIGS. 1 to 3, 5 and 7). The busbar holding member 120 is molded from an insulating material such as synthetic resin.

The busbar holding member 120 includes a busbar holding part 121 configured to hold the second terminal connection part 111 in a state in which the male screw insertion hole 111a is exposed and the fitted connection part 112 protrudes therefrom (FIGS. 2, 3, 5, and 7). The busbar holding part 121 holds three second busbars 110. For example, the busbar holding member 120 is insert-molded by pouring a liquid synthetic resin material into a mold in which the second busbar 110 is placed.

The second terminal block 101 includes a fitting member 131 configured to fit into the busbar holding member 120 from a side closer to the second terminal connection parts 111 of the three second busbars 110 (FIGS. 2, 5, and 7). The second terminal block 101 further includes an annular gasket 132 for each second busbar 110 between the busbar holding member 120 and the fitting member 131 (FIGS. 2, 5. and 7). The second terminal connection part 111 of the second busbar 110 is inserted into the gasket 132. The fitting member 131 holds the gaskets 132 to prevent the gaskets 132 from coming off the second terminal connection part 111.

The busbar holding member 120 includes an oval flange part 122 (FIGS. 1 to 5 and 7). The flange part 122 is disposed on the outer wall of the busbar holding part 121 on the fitted connection part 112 side.

The second terminal block 101 includes a flat metal plate member 140 circularly protruding from the outer circumferential surface of the flange part 122 (FIGS. 1 to 5 and 7). The second terminal block 101 is attached to the second casing by fixing the outer circumferential edge of the plate member 140 to the second casing with a male screw member (not illustrated). Note that, for example, the busbar holding member 120 is insert-molded with a liquid synthetic resin material poured into a mold in which the plate member 140 is placed.

The terminal block TB1 is configured such that, by assembling the first terminal block 1 to the second terminal block 101, the fitted connection part 112 of the second busbar 110 is fitted into the accommodation chamber 21 of the housing 30, and the wedge-shaped connection part 12 of the first busbar 10 in the accommodation chamber 21 is fitted into the V-bank of the fitted connection part 112. Thus, in the terminal block TB1, the first pressing force is exerted between the first piece 12a of the wedge-shaped connection part 12 and the first connection part 112a of the fitted connection part 112, and the second pressing force is exerted between the second piece 12b of the wedge-shaped connection part 12 and the second connection part 112b of the fitted connection part 112. Hence, in the terminal block TB1, contact pressure is generated between the first piece 12a and the first connection part 112a and contact pressure is generated between the second piece 12b and the second connection part 112b.

As described above, the terminal block TB1 of the present embodiment can enhance the workability of assembling the first terminal block 1 to the second terminal block 101 at low cost. Furthermore, in the terminal block TB1 of the present embodiment, the fitted connection part 112 has springiness, and therefore contact pressure can be generated between the wedge-shaped connection part 12 and the fitted connection part 112 even when the amount of the wedge-shaped connection part 12 fitted into the V-bank of the fitted connection part 112 is small. Thus, the terminal block TB1 of the present embodiment can also reduce the size of the body.

### Modification

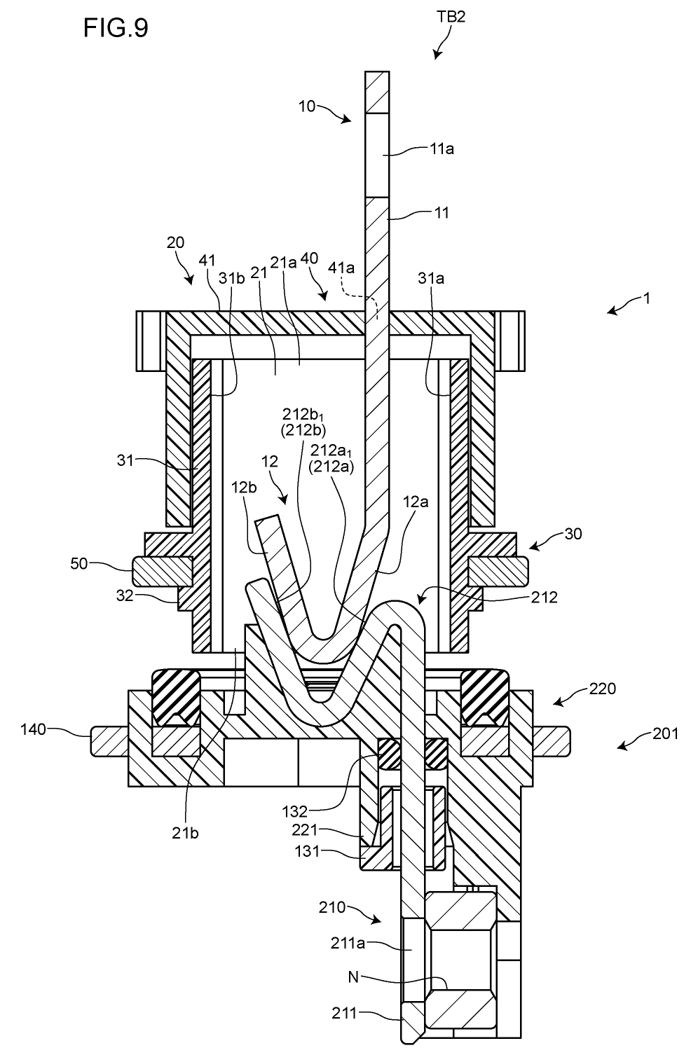

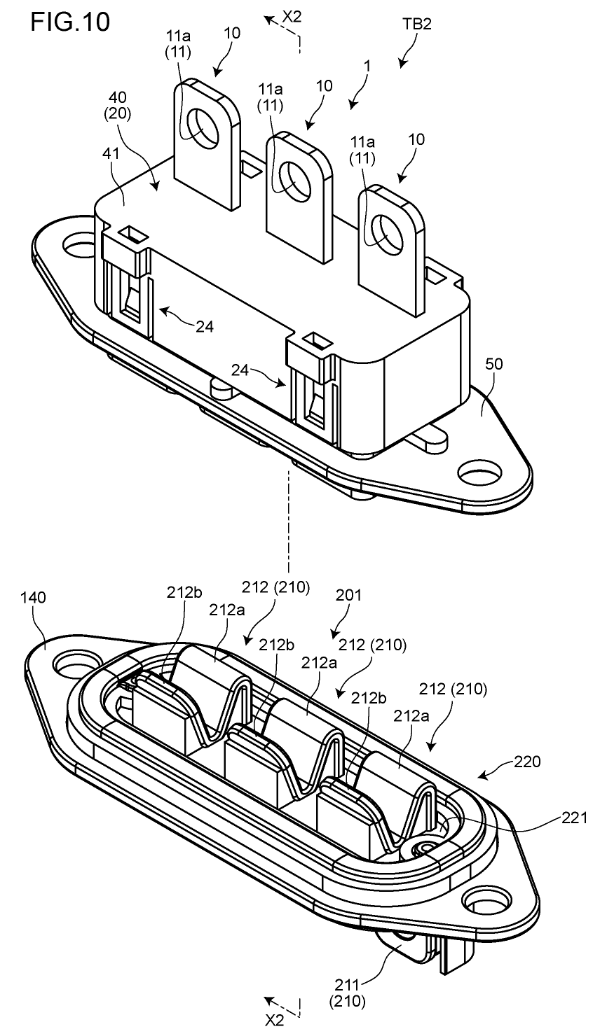

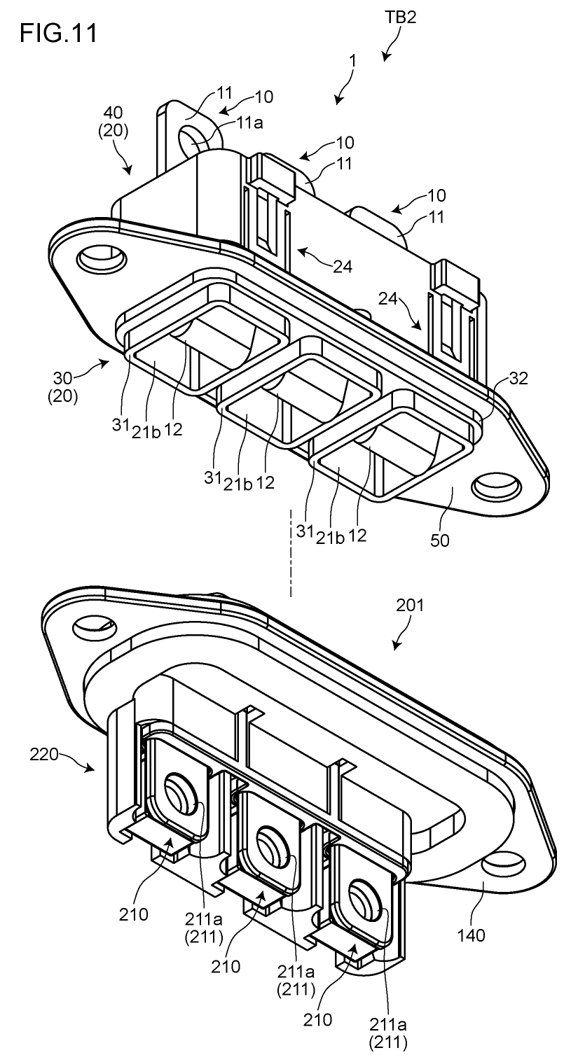

A reference symbol TB2 in FIGS. 9 to 12 represents a terminal block of the present modification. The terminal block TB2 is obtained by replacing the second terminal block 101 of the terminal block TB1 of the aforementioned embodiment with a second terminal block 201 described below. The second terminal block 201 of the present modification is obtained by replacing the second busbar 110 and the busbar holding member 120 of the second terminal block 101 of the aforementioned embodiment with a second busbar 210 and a busbar holding member 220 described below. However, in the first terminal block 1 of the present modification, the first busbar 10 is disposed in such a manner that the wedge-shaped connection part 12 is positioned closer to the opening 21b of the tubular part 31 than in the aforementioned embodiment.

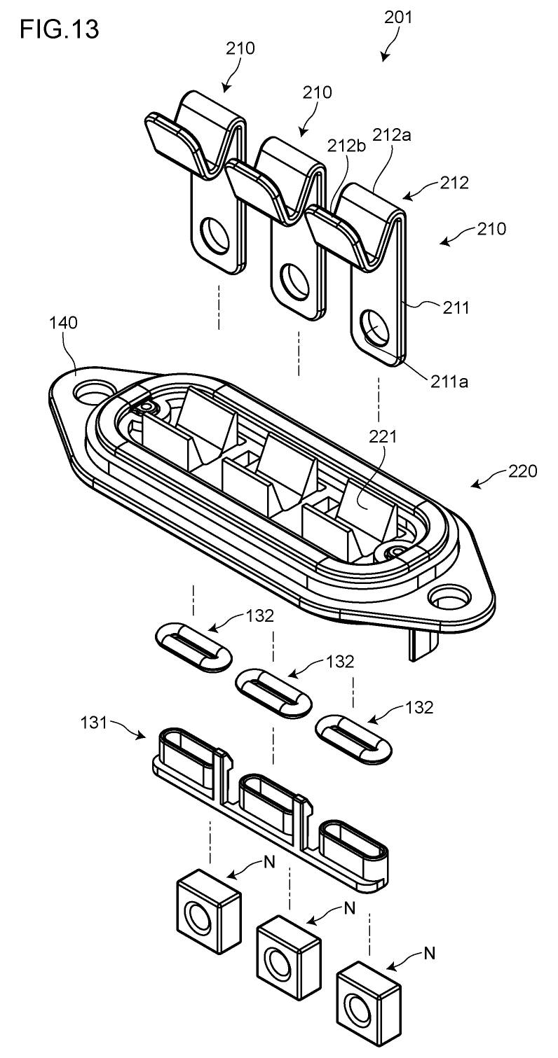

The second busbar 210 of the present modification includes a second terminal connection part 211 including a male screw insertion hole 211a, like the second busbar 110 of the aforementioned embodiment (FIGS. 9 to 13). The second terminal connection part 211 is formed as the equivalent of the second terminal connection part 111 of the embodiment.

Like the second busbar 110 of the embodiment, the second busbar 210 of the present modification includes a fitted connection part 212 configured to allow the wedge-shaped connection part 12 inserted from the fold point to be fitted thereinto (FIGS. 9, 10, 12, and 13). The fitted connection part 212 includes: a first connection part 212a configured to exert a first pressing force on the outer wall of the first piece 12a at an assembly completion position of the first terminal block 1 and the second terminal block 201; and a second connection part 212b configured to exert a second pressing force on the outer wall of the second piece 12b at the assembly completion position.

Note that the fitted connection part 212 of the present modification is V-shaped and cantilevered to include the first connection part 212a being on a fixed end side and connected to the second terminal connection part 211 and the second connection part 212b being on a free end side and connected to the first connection part 212a via the fold point (FIGS. 9, 12, and 13).

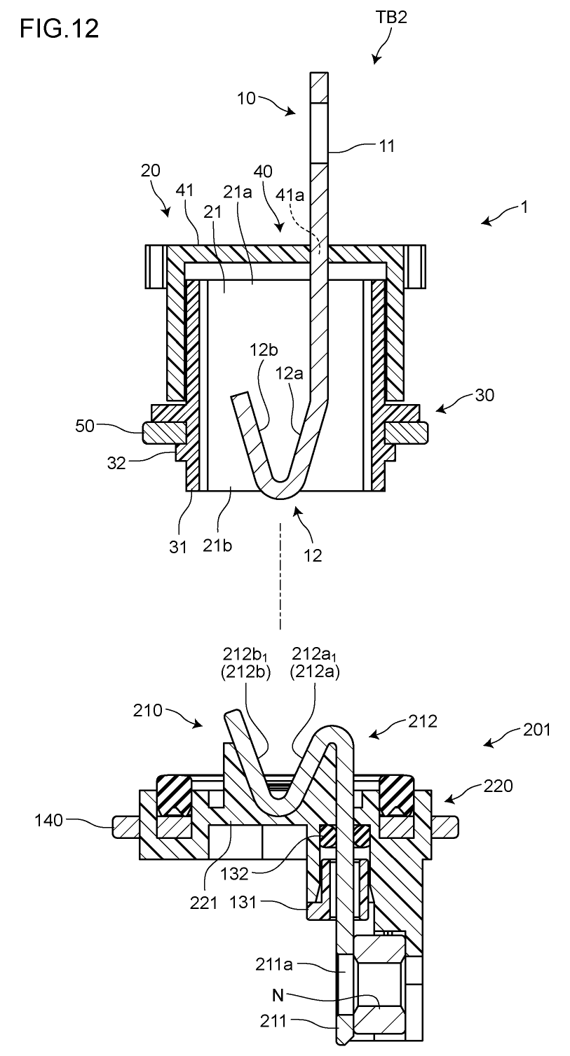

The first connection part 212a is formed as a piece folded back from one longitudinal end of the second terminal connection part 211 toward the fitting direction of the wedge-shaped connection part 12 (FIGS. 9, 12, and 13). The first connection part 212a includes an inner wall 212a₁ disposed to face the outer wall of the first piece 12a and configured to exert the first pressing force on the outer wall of the first piece 12a (FIGS. 9 and 12).

A distal end of the first connection part 212a folded back from the one longitudinal end of the second terminal connection part 211 is coupled to the second connection part 212b. The second connection part 212bis formed as a piece folded back from the distal end toward a direction opposite to the fitting direction of the wedge-shaped connection part 12 (FIGS. 9, 12, and 13). The second connection part 212b includes an inner wall 212b₁ disposed to face the outer wall of the second piece 12b and configured to exert the second pressing force on the outer wall of the second piece 12b (FIGS. 9 and 12).

In the fitted connection part 212, the first connection part 212a and the second connection part 212b are disposed to form a V shape. As the first connection part 112aand the second connection part 112b of the embodiment, the first connection part 212a and the second connection part 212b form an angle θ2 larger than an angle θ1 formed by the first piece 12a and the second piece 12b. Note that the angle θ2 may be equal to that formed by the first connection part 112a and the second connection part 112b of the embodiment, or may be different from that formed by the first connection part 112a and the second connection part 112b of the embodiment.

The busbar holding member 220 of the present modification includes a busbar holding part 221 configured to hold the second terminal connection part 211 with the male screw insertion hole 211a exposed and hold the outer walls of the first connection part 212a and the second connection part 212b of the fitted connection part 212 (FIGS. 9, 10, 12, and 13). The busbar holding part 221 holds three second busbars 210.

For example, the busbar holding member 220 is insert-molded by pouring a liquid synthetic resin material into a mold in which the second busbar 210 is placed.

In the busbar holding member 220, the busbar holding part 221 supports the outer wall of the first connection part 212aand the outer wall of the second connection part 212b. Hence, by exerting a first pressing force on the inner wall 212a₁ of the first connection part 212a from the outer wall of the first piece 12aof the wedge-shaped connection part 12 and exerting a second pressing force on the inner wall 212b₁of the second connection part 212b from the outer wall of the second piece 12b of the wedge-shaped connection part 12, the busbar holding part 221 receives the first pressing force and the second pressing force. Thus, the wedge-shaped connection part 12 is elastically deformed when the first piece 12a and the second piece 12b receive the first pressing force from the first connection part 212a and the second pressing force from the second connection part 212b, respectively. The wedge-shaped connection part 12 receives the first pressing force from the first connection part 212a and the second pressing force from the second connection part 212b to reduce the angle θ1 formed by the first piece 12a and the second piece 12b within an elastic range, and returns the reaction forces (the first pressing force and the second pressing force) associated with elastic deformation to the first connection part 212a and the second connection part 212b, respectively. Thus, contact pressure can be generated between the wedge-shaped connection part 12 and the fitted connection part 212.

The terminal block TB2 of the present modification is configured such that, by assembling the first terminal block 1 to the second terminal block 201, the fitted connection part 212 of the second busbar 210 is fitted into the accommodation chamber 21 of the housing 30, and the wedge-shaped connection part 12 of the first busbar 10 in the accommodation chamber 21 is fitted into the V-bank of the fitted connection part 212. Thus, in the terminal block TB2, the first pressing force is exerted between the first piece 12a of the wedge-shaped connection part 12 and the first connection part 212a of the fitted connection part 212, and the second pressing force is exerted between the second piece 12b of the wedge-shaped connection part 12 and the second connection part 212b of the fitted connection part 212. Hence, in the terminal block TB2, contact pressure is generated between the first piece 12a and the first connection part 212a, and also contact pressure is generated between the second piece 12b and the second connection part 212b.

Like the terminal block TB1 of the embodiment, the terminal block TB2 of the present modification can enhance the workability of assembling the first terminal block 1 to the second terminal block 201 at low cost.

The terminal block according to the present embodiment is configured such that the wedge-shaped connection part is formed in a V shape by the first piece and the second piece, and the fitted connection part is formed in a V shape by the first connection part and the second connection part, and the wedge-shaped connection part in the V shape is fitted into the V-bank of the fitted connection part. Therefore, the terminal block can reduce redoing work such as reassembly caused by, for example, a fitting trouble between the wedge-shaped connection part and the fitted connection part when the first terminal block is assembled to the second terminal block. Thus, the terminal block according to the present embodiment can enhance the workability of assembling the first terminal block to the second terminal block.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block, comprising:
a first terminal block including a first busbar and a case configured to accommodate the first busbar; and
a second terminal block
including a second busbar and a busbar holding member configured to hold the second busbar, and
configured to be fitted and connected to the first terminal block at an assembly completion position,
wherein the first busbar includes
a first terminal connection part configured to establish physical and electrical connections to a terminal fitting of a first electrical apparatus, and
a wedge-shaped connection part being V-shaped and cantilevered and including a fold point positioned on a side closer to the second busbar,
the second busbar includes
a second terminal connection part configured to establish physical and electrical connections to a terminal fitting of a second electrical apparatus, and
a fitted connection part configured to allow the wedge-shaped connection part inserted from the fold point to be fitted into the fitted connection part,
the wedge-shaped connection part includes
a first piece being on a fixed end side and connected to the first terminal connection part, and
a second piece being on a free end side and connected to the first piece via the fold point, and
the fitted connection part includes
a first connection part configured to exert a first pressing force on an outer wall of the first piece at the assembly completion position, and
a second connection part configured to exert a second pressing force on an outer wall of the second piece at the assembly completion position.

2. The terminal block according to claim 1, wherein
the fitted connection part further includes
a first coupling part coupling the second terminal connection part to the first connection part, and
a second coupling part coupling the second terminal connection part to the second connection part,
the first connection part is formed as a piece folded back from the first coupling part toward a fitting direction of the wedge-shaped connection part and includes a first facing wall disposed to face the outer wall of the first piece and configured to exert the first pressing force on the outer wall of the first piece,
the second connection part is formed as a piece folded back from the second coupling part toward the fitting direction of the wedge-shaped connection part and includes a second facing wall disposed to face the outer wall of the second piece and configured to exert the second pressing force on the outer wall of the second piece, and
a first virtual wall including the first facing wall and a second virtual wall including the second facing wall form an angle larger than an angle formed by the first piece and the second piece.

3. The terminal block according to claim 1, wherein
the fitted connection part undergoes elastic deformation by receiving input from the first piece and the second piece and exerts reaction forces associated with the elastic deformation as pressing forces on the first piece and the second piece, respectively.

4. The terminal block according to claim 2, wherein
the fitted connection part undergoes elastic deformation by receiving input from the first piece and the second piece and exerts reaction forces associated with the elastic deformation as pressing forces on the first piece and the second piece, respectively.

5. The terminal block according to claim 1, wherein
the fitted connection part is V-shaped and cantilevered and includes the first connection part being on a fixed end side and connected to the second terminal connection part and the second connection part being on a free end side and connected to the first connection part via a fold point,
the first connection part includes an inner wall disposed to face the outer wall of the first piece and configured to exert the first pressing force on the outer wall of the first piece,
the second connection part includes an inner wall disposed to face the outer wall of the second piece and configured to exert the second pressing force on the outer wall of the second piece, and
the first connection part and the second connection part form an angle larger than an angle formed by the first piece and the second piece.

6. The terminal block according to claim 1,
wherein the wedge-shaped connection part receives the first pressing force from the first connection part and the second pressing force from the second connection part to reduce the angle formed by the first piece and the second piece within an elastic range, and returns reaction forces associated with the elastic deformation to the first connection part and the second connection part, respectively.

7. The terminal block according to claim 2,
wherein the wedge-shaped connection part receives the first pressing force from the first connection part and the second pressing force from the second connection part to reduce the angle formed by the first piece and the second piece within an elastic range, and returns reaction forces associated with the elastic deformation to the first connection part and the second connection part, respectively.
